(19) United States
(12) Patent Application Publication
(10) Pub. No.: US 2026/0154392 A1
(43) Pub. Date: Jun. 4, 2026

(54) AUTHENTICATION APPARATUS FOR MOBILE DEVICE

(71) Applicant: Capital One Services, LLC, McLean, VA (US)

(72) Inventors: Kevin Osborn, McLean, VA (US); Srinivasa Chigurupati, McLean, VA (US); David Kelly Wurmfeld, McLean, VA (US); Lori Roberson, McLean, VA (US)

(73) Assignee: Capital One Services, LLC, McLean, VA (US)

(21) Appl. No.: 18/968,009

(22) Filed: Dec. 4, 2024

(51) Int. Cl. G06F 21/34

(52) U.S. Cl. CPC G06F 21/34

(57) ABSTRACT

Provided herein are authentication apparatuses for mobile devices. In one approach, an authentication apparatus may include a body connected to a protective covering for the mobile device, and a portable authentication device coupleable to the body. The portable authentication device and the body are biasable between a first position and a second position, wherein in the first position the portable authentication device is positioned proximate a short-range wireless communication transceiver of the mobile device to enable communication between the short-range wireless communication transceiver and the portable authentication device, and wherein in the second position the portable authentication device is positioned away from the short-range wireless communication transceiver of the mobile device to prevent communication between the short-range wireless communication transceiver and the portable authentication device.

### FIELD OF THE DISCLOSURE

The disclosure relates generally to authentication approaches and, more particularly, to an authentication apparatus for a mobile device.

### BACKGROUND OF THE DISCLOSURE

Authentication systems authenticate the purported identity of a user wishing to gain access to a given electronic system. Multi-Factor Authentication (MFA) systems enhance security by requiring users to provide multiple different types of credentials before the MFA systems consider the user to be authenticated. For example, an MFA system could require, in addition to a standard credential such as a password, one or more of other types of credentials, such as biometric credentials (e.g., fingerprints), push notifications, one-time passwords received through other channels such as text messaging, an external hardware device, or the like.

Credential types involving hardware devices, such as portable universal serial bus (USB)—type devices that are separate from the device that the user is using to access resources (e.g., a smartphone or mobile tablet), provide strong security by relying on physical possession of a unique piece of hardware, which may additionally be secured by its own credentials. When a particular secondary credential involves such a separate hardware device, the user must take express actions to provide secondary credentials for an MFA system via the separate device. For example, the user may be required to bring the hardware device and the smartphone in proximity to one another as part of an authentication protocol. However, hardware devices are relatively small and prone to being lost or misplaced.

Therefore, it would be beneficial to provide an authentication apparatus including a portable hardware authentication device operable with a mobile device. It is with respect to this and other considerations, the present disclosure is provided.

### SUMMARY

This Summary is provided to introduce a selection of concepts in a simplified form further described below in the Detailed Description. This Summary is not intended to identify key features or essential features of the claimed subject matter, nor is the summary intended as an aid in determining the scope of the claimed subject matter.

In one embodiment, an authentication system may include a protective covering surrounding a mobile device, and an authentication apparatus connected to the protective covering. The authentication apparatus may include a body coupled to the protective covering, and a portable authentication device coupleable to the body, wherein the portable authentication device and the body are biasable between a first position and a second position, wherein in the first position the portable authentication device is positioned proximate a communication element of the mobile device to enable communication between the communication element and the portable authentication device, and wherein in the second position the portable authentication device is positioned away from the communication element of the mobile device to prevent communication between the communication element and the portable authentication device.

In another embodiment, an authentication apparatus for a mobile device may include a body connected to a protective covering for the mobile device, and a portable authentication device coupleable to the body. The portable authentication device and the body are biasable between a first position and a second position, wherein in the first position the portable authentication device is positioned proximate a short-range wireless communication transceiver of the mobile device to enable communication between the short-range wireless communication transceiver and the portable authentication device, and wherein in the second position the portable authentication device is positioned away from the short-range wireless communication transceiver of the mobile device to prevent communication between the short-range wireless communication transceiver and the portable authentication device.

In yet another embodiment, an authentication apparatus connected to a protective covering for a mobile device may include a body coupled to the protective covering, and a physical authentication device coupleable to the body. The physical authentication device and the body are biasable between a first position and a second position, wherein in the first position the physical authentication device is positioned proximate a first near field communication (NFC) element within the mobile device to enable communication using a short-range wireless communication protocol between the first NFC element and a second NFC element within the physical authentication device, and wherein in the second position the physical authentication device is positionable away from the first NFC element of the mobile device to prevent communication between the first NFC element and the second NFC element.

### BRIEF DESCRIPTION OF THE DRAWINGS

By way of example, embodiments of the disclosure will now be described, with reference to the accompanying drawings, in which:

FIGS. 1A-1B depict an authentication system including an authentication apparatus connected to a protective covering for a mobile device, according to embodiments of the present disclosure;

FIGS. 2A-2B demonstrate an approach for securing the portable authentication device within a structure of the authentication apparatus, according to embodiments of the present disclosure;

FIG. 3 is an end view of the authentication apparatus along cutline X-X′ of FIG. 2B, according to embodiments of the present disclosure;

FIGS. 4A-4B depict another authentication system including an authentication apparatus connected to a protective covering for a mobile device, according to embodiments of the present disclosure;

FIGS. 5A-5B depict another authentication system including an authentication apparatus connected to a protective covering for a mobile device, according to embodiments of the present disclosure;

FIG. 6 depicts another authentication system including an authentication apparatus connected to a protective covering for a mobile device, according to embodiments of the present disclosure;

FIGS. 7A-7C depicts various examples of authentication apparatuses, according to embodiments of the present disclosure;

FIG. 8 is a flowchart depicting a method according to embodiments of the present disclosure.

The drawings are not necessarily to scale. The drawings are merely representations, not intended to portray specific parameters of the disclosure. The drawings are intended to depict exemplary embodiments of the disclosure, and therefore are not to be considered as limiting in scope. In the drawings, like numbering represents like elements.

Furthermore, certain elements in some of the figures may be omitted, or illustrated not-to-scale, for illustrative clarity. The cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DETAILED DESCRIPTION

Systems, devices, and methods in accordance with the present disclosure will now be described more fully hereinafter with reference to the accompanying drawings, where various embodiments are shown. The systems, devices, and methods may be embodied in many different forms and are not to be construed as being limited to the embodiments set forth herein. Instead, these embodiments are provided so the disclosure will be thorough and complete, and will fully convey the scope of the methods to those skilled in the art.

In view of the foregoing deficiencies identified with the prior art, provided herein are approaches for incorporating an authentication apparatus into a protective covering for a mobile device, wherein the authentication apparatus includes a portable authentication device (e.g., USB-type device) movable between multiple positions for selective communication with a transceiver of the mobile device. In one non-limiting approach, the authentication apparatus may include a pair of rails and a small carriage body that the portable authentication device is secured to. The portable authentication device can be plugged into the carriage body and, when needed, slid into position when prompted to “tap” the security key, e.g., as part of an authentication protocol. The portable authentication device can be slid out of the way after completion. If the portable authentication device is needed externally, it can be removed, e.g., by sliding and unplugging the portable authentication device from the carriage body. The authentication apparatus can be used as one factor of an MFA protocol.

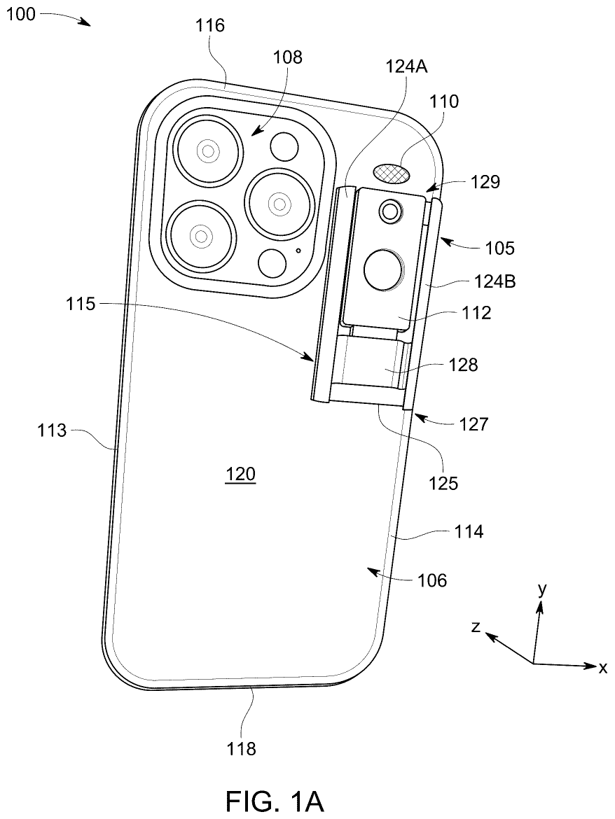

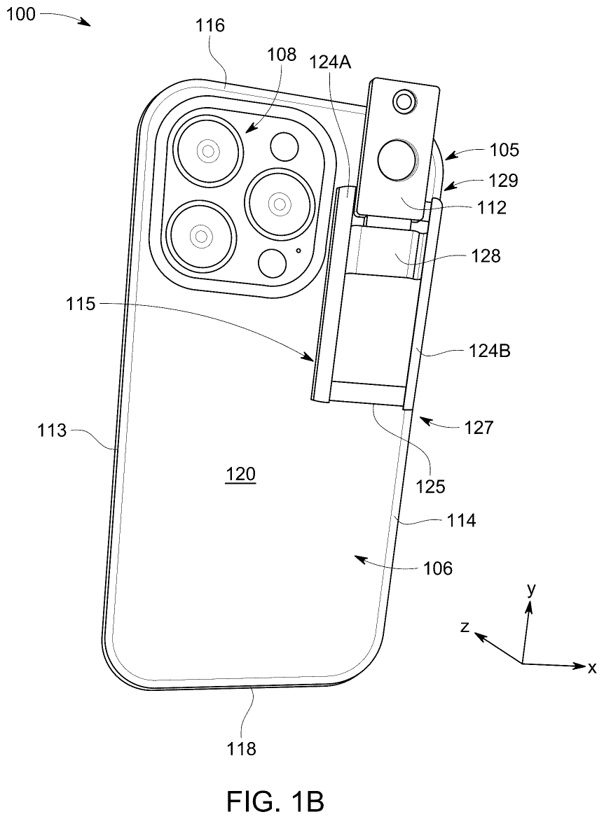

FIGS. 1A-1B show an embodiment of an authentication system 100 including an authentication apparatus 105 connected to a protective covering 106 for a mobile device 108. The mobile device 108 may be, for example, a smartphone, tablet, laptop, or the like, and may include one or more communication elements 110 embedded within. The communication element 110 may be a short-range wireless communication transceiver including a coil or antenna, which is operable to communicate with an external device, such as, in this example, a portable authentication device 112 of the authentication apparatus 105, using any number of communication protocols, e.g., Near Field Communication (NFC), Fast Identity Online (FIDO) 2/WebAuthn, FIDO Universal 2nd Factor (U2F), one time password (OTP), Open Authentication (OATH) time-based one-time password (TOTP), OATH HMAC-based one-time password (HOTP), Smart card (PIV) and OpenPGP, Radio Frequency Identification (RFID), Bluetooth™, and the like. It will be appreciated that the location of the communication element 110 may vary depending on the type and model of the mobile device 108. Furthermore, the mobile device 108 may have hardware and/or software components that provide functionality and/or operations in accordance with the characteristics of that type of mobile device. Storage devices utilized in the mobile device 108 may be composed of, or be any type of, non-transitory storage device that may store instructions and/or software for causing one or more processors to function in accordance with the aspects of the disclosure described herein.

The protective covering 106 may surround a back side of the mobile device 108, and may include a first side 113 opposite a second side 114, and a first end 116 opposite a second end 118. An exterior surface 120 of the protective covering 106 faces away from the mobile device 108, while an interior surface (not visible) faces the back side of the mobile device 108. As shown, the authentication apparatus 105 may be connected to the exterior surface 120 of the protective covering 106. Although non-limiting, the authentication apparatus 105 may be coupled to the exterior surface 120 by an adhesive and/or by other mechanical means. In yet other embodiments, the authentication apparatus 105 may be partially embedded within the protective covering 106, between the exterior surface 120 and the interior surface thereof. As mobile device coverings come in various shapes, sizes, and materials, the present embodiments are not to be limited to any particular type, size, or configuration for the protective covering 106.

In the embodiment shown, the authentication apparatus 105 may include a frame or structure 115 having a set of rails 124A-124B extending in a first direction (e.g., y-direction), and a cross support 125 extending between the set of rails 124A-124B, in a second direction (e.g., x-direction). Each of the rails 124A-124B and the cross support 125 may be directly physically coupled to the exterior surface 120 of the protective covering 106. The rails 124A-124B may extend between a first end 127 and a second end 129 of the structure 115. The authentication apparatus 105 may further include a carriage or body 128 extending between the rails 124A-124B. As will be described in further detail herein, the body 128 may include a set of arms extending into the rails 124A-124B to prevent the body 128 from significantly moving away from the exterior surface 120, e.g., in the z-direction.

Coupled to the body 128 may be the portable authentication device 112. Although non-limiting, the portable authentication device 112 may be a USB - type hardware device, such as USB-A device, a USB-C device, a micro USB device, a lighting USB device, or any other similar device.

During use, the body 128 and the portable authentication device 112 are biasable between a first position, as shown in FIG. 1A, and a second position, as shown in FIG. 1B. In the first position, the portable authentication device 112 is positioned away from the communication element 110 of the mobile device 108, e.g., when the body 128 is at the first end 127 of the structure 115, to prevent communication between the communication element 110 and the portable authentication device 112. In the second position, the portable authentication device 112 is positioned proximate/over the communication element 110 of the mobile device 108, e.g., when the body 128 is at the second end 129 of the structure 115, to enable communication between the communication element 110 and the portable authentication device 112. In some embodiments, the structure 115 may include a stop (not shown) at the first end 127 and/or the second end 129 to prevent the body 128 from sliding out of the rails 124A-124B. Furthermore, in some embodiments, the rails 124A-124B may include internal detents (not shown) to maintain the body 128 in the first position or second position until a sufficient force is applied to the body 128 to change its position along the rails 124A-124B.

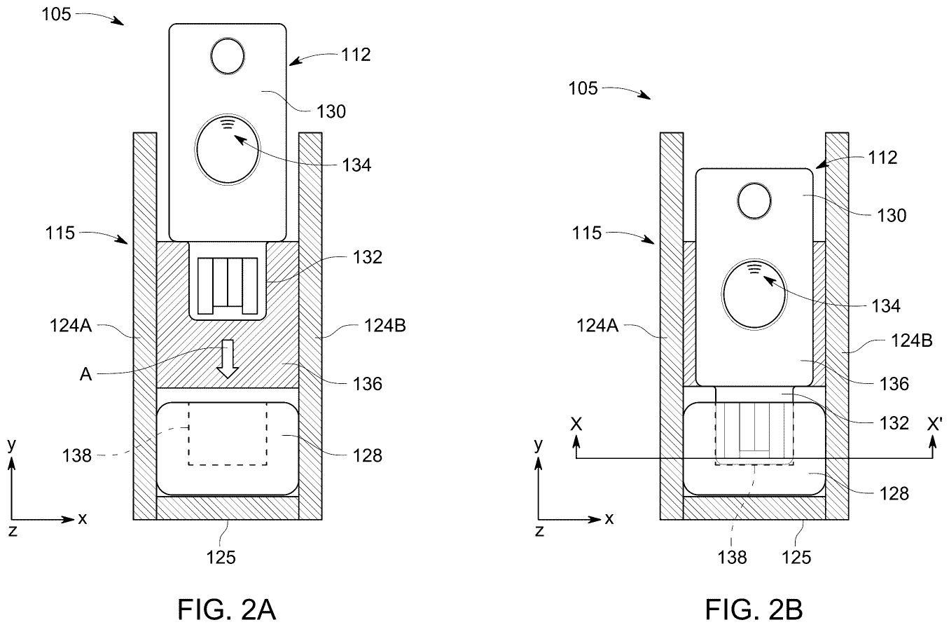

FIGS. 2A-2B demonstrate an approach for securing the portable authentication device 112 within the structure 115 of the authentication apparatus 105. As shown in this non-limiting example, the portable authentication device 112 may be a USB-type FIDO key having a main body 130 and a connector plug 132 extending from the main body 130. Within the main body 130 is a second communication element 134, which may be a short-range wireless communication transceiver (e.g., coil or antenna) operable to communicate with the mobile device 108 using any number of communication protocols, as discussed above. With a FIDO U2F protocol, for example, user authentication may be provided as an NFC tap.

As shown in FIG. 2A, the portable authentication device 112 may be positioned between the rails 124A-124B and over a shielding element 136, which may be present in some examples to limit or prevent communication between the second communication element 134 and the communication element 110 of the mobile device 108 until the portable authentication device 112 is brought into position over the communication element 110. The shielding element 136 may comprise any suitable material(s) of any suitable shape(s), disposed in any configuration(s) suitable for attenuating, blocking, or otherwise affecting NFC and/or other communication signals between the second communication element 134 and the communication element 110. In some embodiments, the shielding element 136 may include ferrite, or other electromagnetic interference (“EMI”) or radio-frequency interference (“RFI”) shielding material.

The portable authentication device 112 may be inserted (as shown by arrow ‘A’) into the body 128 until the connector plug 132 is positioned within a port or slot 138 of the body 128, as shown in FIG. 2B. In some embodiments, the slot is 138 is specifically configured to receive the connector plug 132 of USB-type FIDO key. In other embodiments, the internal configuration of the slot 138 is more generic to receive connector plugs of different types, sizes, shapes, etc. In still other embodiments, the body 128 may be configured to engage the main body 130 of the portable authentication device 112 instead of the connector plug 132. For example, the main body 130 of the portable authentication device 112 may be press-fitted into a corresponding receptacle of the body 128 to couple the body 128 and the portable authentication device 112 together.

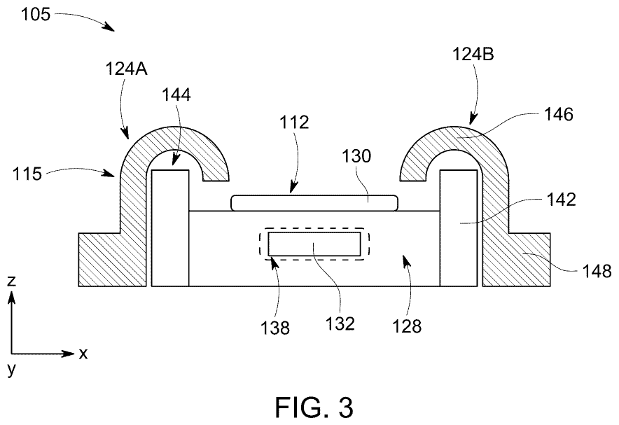

Turning to FIG. 3, an end view of the authentication apparatus 105 along cutline X-X′ of FIG. 2B will be described in greater detail. As shown, the body 128 may include a set of arms 142 extending from opposite sides thereof, wherein the arms 142 extend into an internal channel 144 of each of the rails 124A-124B. The internal channels 144 may be defined by a looped or curved section 146, which extends from a base 148. The base 148 may be in direct contact with the exterior surface 120 of the protective covering 106 (FIGS. 1A-1B) . Once the portable authentication device 112 is coupled to the body 128, the curved section generally 146 prevents the arms 142 from moving in the z-direction, while still permitting sliding movement of the body 128 in the y-direction.

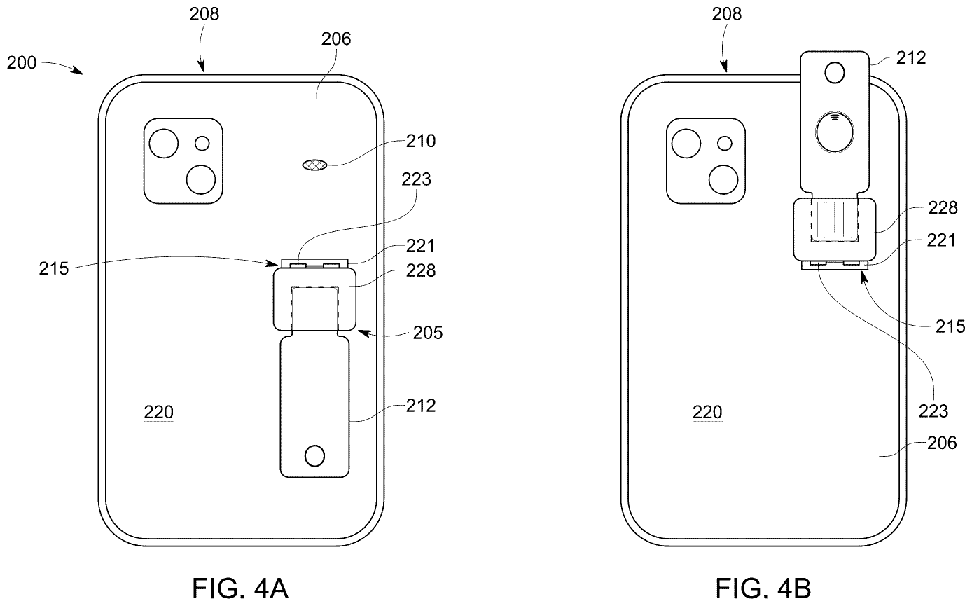

FIGS. 4A-4B show another embodiment of an authentication system 200 including an authentication apparatus 205 connected to a protective covering 206 for a mobile device 208. The authentication system 200 may be the same or similar in many aspects to the authentication system 100 described above. As such, only certain aspects of the authentication system 200 will hereinafter be describe for the sake of brevity. The protective covering 206 may surround a back side of the mobile device 208, and the authentication apparatus 205 may be connected to the exterior surface 220 of the covering 206. Although non-limiting, the authentication apparatus 205 may include an attachment plate 221 coupled to the exterior surface 220 by an adhesive and/or by other mechanical means.

In the embodiment shown, the authentication apparatus 205 may include a frame or structure 215 comprising the attachment plate 221 and a hinge 223 connected to a body 228. Coupled to the body 228 may be a portable authentication device 212. Although non-limiting, the portable authentication device 212 may be a USB - type hardware device, such as USB-A device, a USB-C device, a micro-USB device, a lighting USB device, or any other similar device.

During use, the body 228 and the portable authentication device 212 are biasable between a first position, as shown in FIG. 4A, and a second position, as shown in FIG. 4B. That is, the hinge 223 permits rotation of the portable authentication device 212 about an axis extending through the hinges. In the first position, the portable authentication device 212 is positioned away from a communication element 210 of the mobile device 208 to prevent communication between the communication element 210 and the portable authentication device 212. In the second position, the portable authentication device 212 is rotated proximate/over the communication element 210 of the mobile device 208 to enable communication between the communication element 210 and the portable authentication device 212.

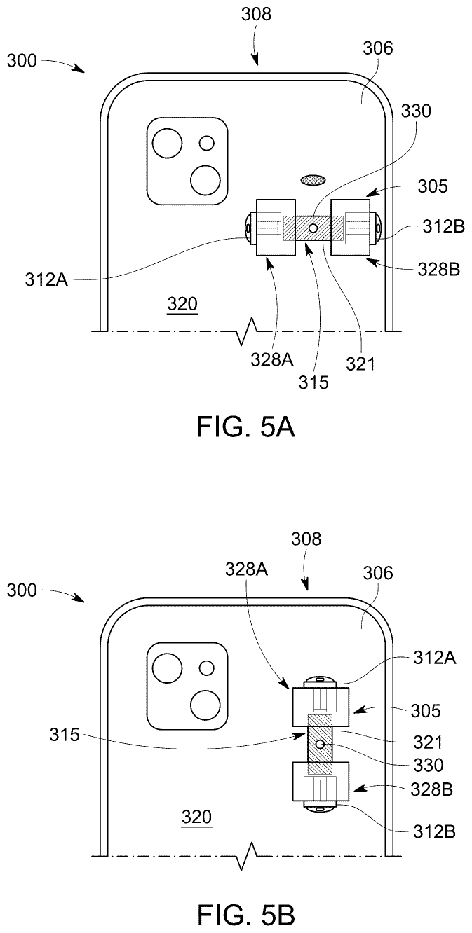

FIGS. 5A-5B show another embodiment of an authentication system 300 including an authentication apparatus 305 connected to a protective covering 306 for a mobile device 308. The authentication system 300 may be the same or similar in many aspects to the authentication systems 100, 200 described above. As such, only certain aspects of the authentication system 300 will hereinafter be describe for the sake of brevity. The protective covering 306 may surround a back side of the mobile device 308, and the authentication apparatus 305 may be rotatably coupled to the covering 306.

In the embodiment shown, the authentication apparatus 305 may include a frame or structure 315 comprising an attachment plate 321 connected to a first body 328A and a second body 328B by a central shaft 330. Coupled to the first body 328A may be a first portable authentication device 312A, and coupled to the second body 328B may be a second portable authentication device 312B. Although non-limiting, the portable authentication devices 312A, 312B may each be a USB - type hardware device, such as a nano hardware security module (HSM).

During use, the authentication apparatus 305 is biasable (i.e., rotatable) about the central shaft 330 between a first position, as shown in FIG. 5A, and a second position, as shown in FIG. 5B. In the first position, both of the portable authentication devices 312A, 312B are positioned away from a communication element 310 of the mobile device 308 to prevent communication therebetween. In the second position, the first portable authentication device 312A is positioned proximate/over the communication element 310 of the mobile device 308 to enable communication between the communication element 310 and the first portable authentication device 312A. In a third position (not shown), the authentication apparatus 305 may be rotated about the central shaft 330 until the second portable authentication device 312B is positioned proximate/over the communication element 310 of the mobile device 308 to enable communication between the communication element 310 and the second portable authentication device 312B.

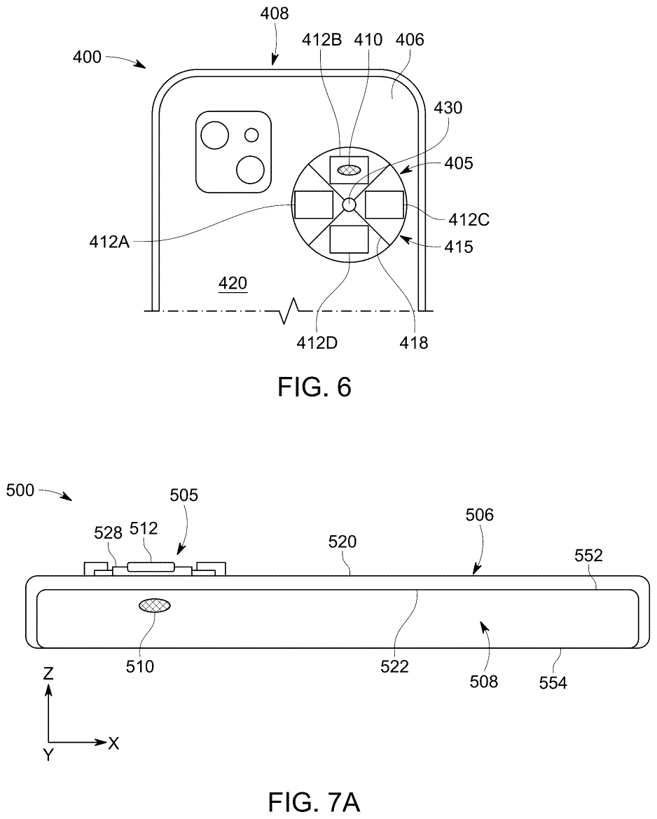

FIG. 6 shows another embodiment of an authentication system 400 including an authentication apparatus 405 connected to a protective covering 406 for a mobile device 408. The authentication system 400 may be the same or similar in many aspects to the authentication systems 100, 200, 300 described above. As such, only certain aspects of the authentication system 400 will hereinafter be describe for the sake of brevity. The protective covering 406 may surround a back side of the mobile device 408, and the authentication apparatus 405 may be rotatably coupled to an exterior surface 420 of the protective covering 406.

In the embodiment shown, the authentication apparatus 405 may include a wheel structure 415 connected to the protective covering 406 by a central shaft 430. As shown, the wheel structure 415 may be divided into multiple sections, e.g., by walls 418. Within each section of the wheel structure 415 is a portable authentication device (e.g., 412A-412D). In some embodiments, the walls 418 may be insulated or lined to block/limit lateral signal transmission from the portable authentication devices 412A-412D. Although non-limiting, the portable authentication devices 412A-412D may be a USB-type hardware device, such as a nano HSM.

During use, the wheel structure 415 is biasable (i.e., rotatable) about the central shaft 430 between multiple positions to align a desired portable authentication device with the communication element 410. In some embodiments, one or more of the sections of the wheel structure 415 may be empty to allow for a position of the wheel structure when no communication is desired with the communication element 410.

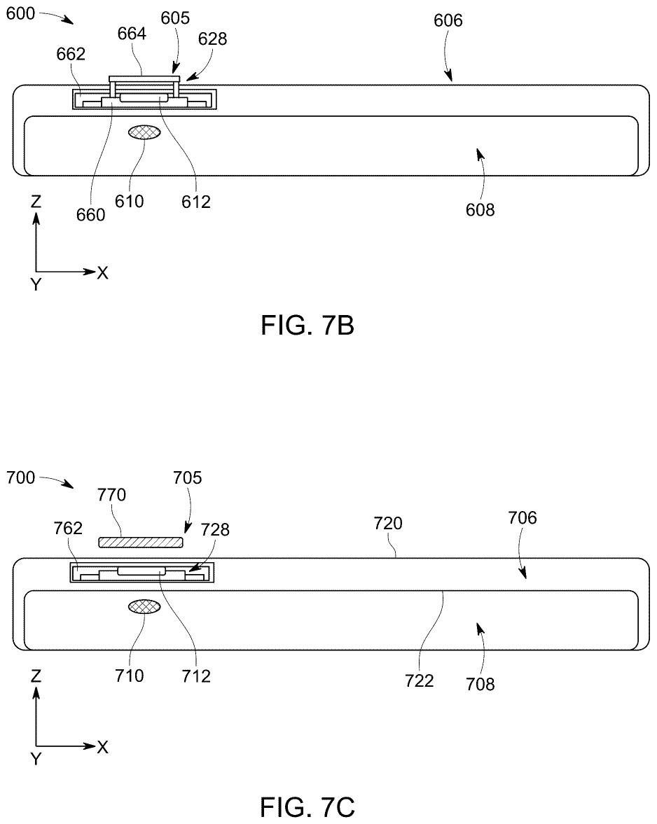

FIG. 7A demonstrates a cross sectional view of an example authentication system 500 according to one or more embodiments of the present disclosure. The authentication system 500 may include an authentication apparatus 505 connected to a protective covering 506 for a mobile device 508. The authentication apparatus 505 may include a body 528 and a portable authentication device 512 positionable over a communication element 510, which is embedded within the mobile device 508. The protective covering 506 may include an exterior surface 520 opposite an interior surface 522, wherein the interior surface 522 is in abutment with a back side 552 of the mobile device 508, and wherein the exterior surface 520 is in direct contact with the authentication apparatus 505. A front side 554 of the mobile device 508 may include a screen/interface. The authentication apparatus 505 may be the same as authentication apparatus 105 described above.

FIG. 7B demonstrates a cross sectional view of an example authentication system 600 according to one or more embodiments of the present disclosure. The authentication system 600 may include an authentication apparatus 605 partially embedded within a protective covering 606 for a mobile device 608. That is, the authentication apparatus 605 may include a body 628 having a first section 660 positioned within a cavity 662 of the protective covering 606, and a second section 664 extending outside the protective covering 606. The cavity 662 may be located between an exterior surface 620 and an interior surface 622 of the protective covering 606. The second section 664 passes through slits in the exterior surface 620. A portable authentication device 612 may be connected to the first section 660, within the cavity 662. To bias the authentication apparatus 605 relative to a communication element 610 of the mobile device 608, a user may engage the second section 664, sliding it in the y-direction.

FIG. 7C demonstrates a cross sectional view of an example authentication system 700 according to one or more embodiments of the present disclosure. In this embodiment, the authentication system 700 may include an authentication apparatus 705 fully embedded within a protective covering 706 for a mobile device 708. That is, the authentication apparatus 705 may include a portable authentication device 712 coupled to a body 728, wherein the portable authentication device 712 and the body 728 are embedded within a cavity 762 located between an exterior surface 720 and an interior surface 722 of the protective covering 706. To bias the authentication apparatus 705 relative to a communication element 710 of the mobile device 708, a magnetic element 770 may be moved over the authentication apparatus 705 to bias the body 728 in the y-direction. It will be appreciated that the body 728 may be constructed from magnetic and/or ferromagnetic materials, and therefore may respond to the magnetic element 770. By fully embedding the authentication apparatus 705 within the protective covering 706, security is enhanced.

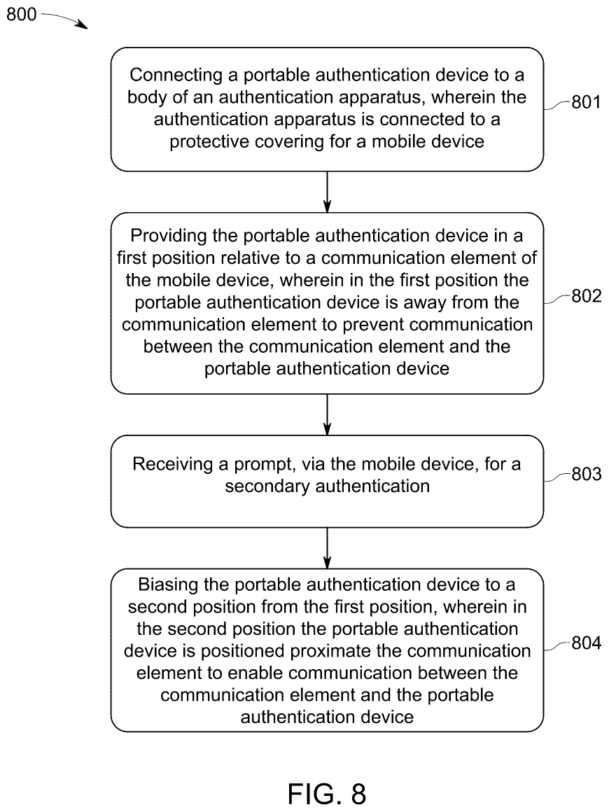

Turning to FIG. 8, a method 800 according to embodiments of the disclosure will be described. In some embodiments, the method 800 may be part of an MFA protocol for accessing a resource via a mobile device. Although non-limiting, the resource may include, for example, applications (e.g., email applications, timekeeping applications, spreadsheet applications, etc.), databases, file systems, or the like. Such applications could be, for example, entirely web-based and accessible through a web browser, or could be accessible through a native application installed on the user's client device and communicating with a remote application server. Embodiments herein are not limited in this context.

At block 801, the method 800 may include connecting a portable authentication device to a body of an authentication apparatus, wherein the authentication apparatus is connected to a protective covering for a mobile device. In some embodiments, the body may include a slot operable to receive a connector plug of the portable authentication device.

At block 802, the method 800 may include providing the portable authentication device in a first position relative to a communication element of the mobile device, wherein in the first position the portable authentication device is located remote to the communication element to prevent communication between the communication element and the portable authentication device.

At block 803, the method 800 may include receiving a prompt, via the mobile device, for a secondary authentication. The secondary authentication request may be generated following successful completion of a primary authentication. Although non-limiting, the primary authentication may be a username/password, biometric credentials (e.g., fingerprints), push notifications, one-time passwords, and many others.

At block 804, the method 800 may include, in response to the secondary authentication prompt, biasing the portable authentication device to a second position from the first position, wherein in the second position the portable authentication device is positioned proximate the communication element to enable communication between the communication element and the portable authentication device.

In some embodiments, the portable authentication device may be a USB-type FIDO key, which uses a set of technology-agnostic security specifications for strong authentication. FIDO specifications support MFA and public key cryptography. Advantageously, the secondary, FIDO-compliant authentication doesn't require use of complex passwords. Instead, the authentication can be provided based on proximity together with personally identifying information to be stored locally on the user's device for security purposes. Bringing the portable authentication device proximate communication element will function as a “tap” gesture, thus initiating communication.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Furthermore, identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

Still furthermore, the terms “substantial” or “substantially,” as well as the terms “approximate” or “approximately,” can be used interchangeably in some embodiments, and can be described using any relative measures acceptable by one of ordinary skill in the art. For example, these terms can serve as a comparison to a reference parameter, to indicate a deviation capable of providing the intended function. Although non-limiting, the deviation from the reference parameter can be, for example, in an amount of less than 1%, less than 3%, less than 5%, less than 10%, less than 15%, less than 20%, and so on.

While certain embodiments of the disclosure have been described herein, the disclosure is not limited thereto, as the disclosure is as broad in scope as the art will allow and the specification may be read likewise. Therefore, the above description is not to be construed as limiting. Those skilled in the art will envision other modifications within the scope and spirit of the claims appended hereto.

What is claimed is:

1. An authentication system, comprising:
a protective covering surrounding a mobile device; and
an authentication apparatus connected to the protective covering, the authentication apparatus comprising:
a body coupled to the protective covering; and
a portable authentication device coupleable to the body, wherein the portable authentication device and the body are biasable between a first position and a second position, wherein in the first position the portable authentication device is positioned proximate a communication element of the mobile device to enable communication between the communication element and the portable authentication device, and wherein in the second position the portable authentication device is positioned away from the communication element of the mobile device to prevent communication between the communication element and the portable authentication device.

2. The authentication system of claim 1, wherein the authentication apparatus further comprises a set of rails, wherein the body is slidably coupled to the set of rails.

3. The authentication system of claim 1, wherein the body comprises a slot operable to receive the portable authentication device.

4. The authentication system of claim 1, wherein the body is rotatably coupled to the protective covering.

5. The authentication system of claim 4, wherein the body is rotatably coupled to the protective covering by one of: a central shaft, and a hinge.

6. The authentication system of claim 1, wherein the authentication apparatus further comprises a shielding element positioned between the communication element and the portable authentication device when the portable authentication device and the body are in the second position.

7. The authentication system of claim 1, wherein the authentication apparatus is coupled to an exterior surface of the protective covering.

8. The authentication system of claim 1, wherein the portable authentication device and the body are partially embedded within the protective covering, between an exterior surface and an interior surface.

9. The authentication system of claim 1, wherein the portable authentication device comprises a near field communication element.

10. An authentication apparatus for a mobile device, the authentication apparatus comprising:
a body connected to a protective covering for the mobile device; and
a portable authentication device coupleable to the body, wherein the portable authentication device and the body are biasable between a first position and a second position, wherein in the first position the portable authentication device is positioned proximate a short-range wireless communication transceiver of the mobile device to enable communication between the short-range wireless communication transceiver and the portable authentication device, and wherein in the second position the portable authentication device is positioned away from the short-range wireless communication transceiver of the mobile device to prevent communication between the short-range wireless communication transceiver and the portable authentication device.

11. The authentication apparatus of claim 10, wherein the authentication apparatus further comprises a set of rails couplable to an exterior surface of the protective covering, wherein the body is slidably coupled to the set of rails.

12. The authentication apparatus of claim 10, wherein the body comprises a slot operable to receive the portable authentication device.

13. The authentication apparatus of claim 10, wherein the body is rotatably coupled to the protective covering by one of: a central shaft, and a hinge.

14. The authentication apparatus of claim 10, wherein the authentication apparatus is coupled to an exterior surface of the protective covering.

15. The authentication apparatus of claim 10, wherein the portable authentication device and the body are partially embedded within the protective covering, between an exterior surface and an interior surface of the protective covering.

16. An authentication apparatus connected to a protective covering for a mobile device, the authentication apparatus comprising:
a body coupled to the protective covering; and
a physical authentication device coupleable to the body, wherein the physical authentication device and the body are biasable between a first position and a second position, wherein in the first position the physical authentication device is positioned proximate a first near field communication (NFC) element within the mobile device to enable communication using a short-range wireless communication protocol between the first NFC element and a second NFC element within the physical authentication device, and wherein in the second position the physical authentication device is positionable away from the first NFC element of the mobile device to prevent communication between the first NFC element and the second NFC element.

17. The authentication apparatus of claim 16, wherein the authentication apparatus further comprises a set of rails couplable to an exterior surface of the protective covering, wherein the body is biasable along the set of rails between the first position and the second position.

18. The authentication apparatus of claim 16, wherein the body comprises a port operable to receive a connector plug of the physical authentication device.

19. The authentication apparatus of claim 16, wherein the body is rotatably coupled to the protective covering by one of: a central shaft, and a hinge.

20. The authentication apparatus of claim 16, wherein the physical authentication device is a universal serial bus (USB)-type hardware device.
